(19) United States
(12) Patent Application Publication
(10) Pub. No.: US 2026/0136200 A1
(43) Pub. Date: May 14, 2026

(54) Bluetooth Low Energy Transport Discovery Service

(71) Applicant: Apple Inc., Cupertino, CA (US)

(72) Inventors: Yong Liu, Campbell, CA (US); Charles F Dominguez, San Carlos, CA (US); Su Khiong Yong, Palo Alto, CA (US); Yupeng Zhang, San Diego, CA (US)

(21) Appl. No.: 19/329,171

(22) Filed: Sep. 15, 2025

Related U.S. Application Data
(60) Provisional application No. 63/718,328, filed on Nov. 8, 2024.

(51) Int. Cl. H04W 12/50; H04W 4/80; H04W 8/00; H04W 12/0471; H04W 84/18

(52) U.S. Cl. CPC H04W 12/50; H04W 4/80; H04W 8/005; H04W 12/0471; H04W 84/18

(57) ABSTRACT

An electronic device is described. During operation, the electronic device can perform neighborhood area network (NAN) pairing with a second electronic device, where, during the NAN pairing, the electronic device and the second electronic device exchange NAN identity keys (NIKs) or trigger identity keys (TIKs). Note that the NAN pairing can convey a BLE trigger capability of the second electronic device to the electronic device. Moreover, the electronic device can provide, addressed to the second electronic device, a Bluetooth Low Energy (BLE) transportation discovery service (TDS) frame, wherein the BLE TDS frame includes an identity tag (ITag) corresponding to packet data in the BLE TDS frame and an NIK of the electronic device or a TIK of the electronic device.

### CROSS-REFERENCE TO RELATED APPLICATION

This application claims the benefit of U.S. Provisional Application No. 63/718,328, entitled “Bluetooth Low Energy Transportation Discovery Service,” by Yong Liu, et al., filed Nov. 8, 2024, the contents of both of which are hereby incorporated by reference.

### FIELD

The described embodiments relate, generally, to wireless communication among electronic devices, including a Bluetooth Low Energy (BLE) Transport Discovery Service (TDS).

### BACKGROUND

Many electronic devices communicate with each other using wireless local area networks (WLANs), such as those based on a communication protocol that is compatible with an Institute of Electrical and Electronics Engineers (IEEE) 802.11 standard (which is sometimes referred to as ‘Wi-Fi’). Wi-Fi Aware (such as the proposed Wi-Fi Aware R5) extends Wi-Fi capability with quick discovery, connection, and data exchange with other Wi-Fi devices, without the need for a traditional network infrastructure, Internet connection, or GPS signal.

Moreover, a Bluetooth Low Energy or BLE (from the Bluetooth Special Interest Group of Kirkland, Washington) Transport Discovery Service (TDS) can be used to wake up neighborhood area network (NAN) interfaces and/or Wi-Fi discovery of nearby or proximate electronic devices, such as televisions. However, waking up the NAN interfaces of unintended electronic devices would cause unnecessary power consumption and NAN operation overhead.

Furthermore, BLE TDS can be used for triggering Wi-Fi peer-to-peer (P2P) communication. The BLE TDS frame format can include: an advanced data (AD) length (e.g., 1 octet), an AD type (such as TDS, which can be 1 octet), an organization identifier (e.g., 1 octet), a TDS flag (e.g., 1 octet), a TDS length (e.g., 1 octet), a TDS header (e.g., 1 octet), a Bloom Filter payload (e.g., 10-20 octets) and/or an optional channel (e.g., 2 octets). In the TDS flag, bits 0 and 1 can specify the frame role, bit 2 can specify transport data incomplete, bits 3 and 4 can specify the transport state, and bits 5-7 may be reserved. Moreover, in the TDS header, bit 0 can specify the Bloom Filter length, bits 1-6 may be reserved, and bit 7 can indicate whether (or not) channel information is present. Note that a Bloom Filter element can include: operation, parameters, a service name, and a data link identifier. Thus, the Bloom Filter can indicate a service name, a data link identifier and/or corresponding operations of one or multiple services. In some embodiments the BLE TDS frame can optionally indicate an operation channel of a Wi-Fi P2P interface.

An example of an existing Bloom Filter is shown in FIG. 1. A Bloom Filter can compress multiple elements (e.g., 10 or 20 B) into a bit map. These elements can be hashed into the Bloom Filter. The resulting compression allows the elements to be conveyed more efficiently. For example, multiple elements, each indicated by four disparate points within an 80 or 160 b range, can be combined into a Bloom Filter.

Additionally, generating a Bloom filter can use a SipHash with a fixed key of ‘00 00 00 00 00 00 00 00 00 00 00 00 00 00 00 01’ and a hash count of four. SipHash can generate a 64-bit hash. Consequently, a single invocation can provide enough randomness for all four hashes. The first bit index can use the 64-bit SipHash result mod bitCount, where bitCount is the number of bits for a 10 or 20 B Bloom Filter. The result can be divided by bitCount and then modulo with bitCount to generate the second bit index, and so on to generate all four-bit indexes. The resulting bits can be set to form the Bloom Filter.

However, there are some problems associated with the existing Bloom Filter-based protocols. For example, a Bloom Filter can be subject to a pollution attack. Notably, when a malicious electronic device sends faked BLE TDS frames with all bits of the Bloom Filter set to ‘1’ (or with most bits of the Bloom Filter set to ‘1’), a receiving device can always find a four-point match for any service element. Consequently, these faked BLE TDS frames would trigger all (or most) receiving electronic devices, which are scanning for the BLE TDS frames to turn on NAN or other high-power interfaces.

The existing Bloom-Filter protocols can also raise privacy concerns. Notably, the Bloom Filter payload in a BLE TDS frame can have fixed service information elements. The fixed service element(s) hashed into the Bloom Filter can: make a BLE TDS transmitter become a tracking target; and/or reveal the service provider(s) in the neighborhood.

### SUMMARY

An electronic device is described. This electronic device includes: an antenna node communicatively coupled to an antenna; and one or more interface circuits, communicatively coupled to the antenna node. During operation, the one or more interface circuits perform NAN pairing with a second electronic device. Note that, during the NAN pairing, the electronic device and the second electronic device exchange NAN identity keys (NIKs) or trigger identity keys (TIKs). Moreover, the one or more interface circuits provide, addressed to the second electronic device, a BLE TDS frame, where the BLE TDS frame includes an identity tag (ITag) corresponding to packet data in the BLE TDS frame and an NIK of the electronic device or a TIK of the electronic device.

Note that the ITag can equal N bits in a hash of the packet data and the NIK or the TIK. For example, the hash can be performed using a SipHash function.

Moreover, the packet data can include all fields in the BLE TDS frame preceding the ITag.

Furthermore, the BLE TDS frame can include a Bloom Filter field with information corresponding to select information elements in a data stream and a timestamp of the electronic device. For example, the timestamp can include a UnixTime of the electronic device. Unix Time, also known as Epoch time or POSIX time, is a system for tracking time as a single number representing the number of non-leap seconds that have elapsed since 00:00:00 Coordinated Universal Time (UTC) on Thursday, 1 Jan. 1970. This specific moment is known as the Unix epoch. In order to accommodate clock drift caused by delayed Unix Time synchronization, the timestamp can be calculated as timestamp=Unix Time/(window. 60 mins. 60 secs). The window can be 2 hours, 1 hour, 30 min, 15 min, etc. Moreover, the window value can be included in the Header Extension field. Additionally, the information can correspond to a hash of the select information elements and the timestamp. The hash can be performed using a SipHash function. Alternatively or additionally, the NIK or the TIK can include a key of a hash function that performs the hash. In some embodiments, the information can correspond to a nonce.

Note that the information can correspond to a hash of the select information elements, the timestamp and the nonce, and/or the nonce can be changed in different BLE TDS frames. Moreover, the information can correspond to: a value in an AdvA field in the BLE TDS frame; and/or a hash of the select information elements, the timestamp and the value in the AdvA field. Alternatively or additionally, the value in the AdvA field can be changed in different BLE TDS frames, and/or one or more of the NIK, the TIK and the value of the AdvA field can be used to generate a key of a hash function that performs the hash.

The TIK can include: a random number; or correspond to the NIK.

For example, the TIK can include 64 or 128 bits.

Additionally, the BLE TDS frame can include a Bloom Filter field with information corresponding to select information elements in a data stream and the select information elements can be hashed prior to the electronic device generating the Bloom Filter field based at least in part on hashed values of the select information elements.

In some embodiments, the BLE TDS frame can include a Bloom Filter field with information corresponding to select information elements in a data stream that are randomized in the BLE TDS frame.

Note that the ITag of the electronic device can include a Group ITag (GITag) of a group of electronic devices, a source ITag (SITag) or a destination ITag (DITag).

Moreover, the NIK of the electronic device can include a Group NIK (GNIK) of a group of electronic devices. For example, the BLE TDS frame can include a Bloom Filter field with information corresponding to select information elements in a data stream and the GNIK.

Furthermore, the BLE TDS frame can include a TDS header field that indicates one or more of: a length of a Bloom Filter in the BLE TDS frame; a type of ITag present in the BLE TDS frame; whether a timestamp is used to compute a value of the Bloom Filter; and/or whether information elements in a data stream used to compute the value of the Bloom Filter are randomized.

Additionally, the BLE TDS frame can include a header extension field that indicates one or more of: whether the BLE TDS frame comprises a timestamp; a number of ITags included in the BLE TDS frame; and/or types of the one or more ITags.

In some embodiments, the NAN pairing can convey a BLE trigger capability of the second electronic device to the electronic device.

Other embodiments provide the second electronic device that performs counterpart operations to at least some of the operations performed by the electronic device. For example, the second electronic device can include: an antenna node communicatively coupled to an antenna; and one or more interface circuits, communicatively coupled to the antenna node. During operation, the one or more interface circuits can perform NAN pairing with an electronic device. Note that, during the NAN pairing, the electronic device and the second electronic device can exchange NIKs or TIKs. Moreover, the one or more interface circuits can receive, associated with the electronic device, a BLE TDS frame, where the BLE TDS frame includes an ITag corresponding to packet data in the BLE TDS frame and an NIK of the electronic device or a TIK of the electronic device. Furthermore, the one or more interface circuits can identify a paired peer based at least in part on the ITag and the NIK or the TIK of the electronic device.

Note that the identifying can include: generating one or more ITag values based at least in part on the packet data in the received BLE TDS frame and a stored value of the NIKs of paired third electronic devices; comparing the one or more generated ITag values with the ITag value in the BLE TDS frame; and when a match occurs, identifying the paired peer as the second electronic device.

Moreover, the one or more interface circuits can identify a matched service based at least in part on a value of a Bloom Filter in the BLE TDS frame.

Furthermore, the ITag can equal N bits in a hash of the packet data and the NIK or the TIK. For example, the hash can be performed using a SipHash function. Alternatively or additionally, the packet data can include all fields in the received BLE TDS frame preceding the ITag.

Other embodiments provide an integrated circuit (such as one of the one or more interface circuits) for use with the electronic device or the second electronic device. The integrated circuit can perform at least some of the aforementioned operations of the electronic device or the second electronic device.

Other embodiments provide a computer-readable storage medium for use with the electronic device or the second electronic device. When program instructions stored in the computer-readable storage medium are executed by the electronic device or the second electronic device, the program instructions can cause the electronic device or the second electronic device to perform at least some of the aforementioned operations of the electronic device or the second electronic device.

Other embodiments provide a method. The method includes at least some of the aforementioned operations performed by the electronic device or the second electronic device.

This Summary is provided for purposes of illustrating some exemplary embodiments, so as to provide a basic understanding of some aspects of the subject matter described herein. Accordingly, it will be appreciated that the above-described features are only examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The included drawings are for illustrative purposes and serve only to provide examples of possible structures and arrangements for the disclosed systems and techniques for intelligently and efficiently managing communication between multiple associated user devices. These drawings in no way limit any changes in form and detail that can be made to the embodiments by one skilled in the art without departing from the spirit and scope of the embodiments. The embodiments will be readily understood by the following detailed description in conjunction with the accompanying drawings, where like reference numerals designate like structural elements.

FIG. 1 is a drawing illustrating an example of an existing Bloom filter.

FIG. 2 is a block diagram illustrating an example of communication between electronic devices.

FIG. 3 is a block diagram illustrating an example of communication between electronic devices.

FIG. 4 is a flow diagram illustrating an example method for providing a Bluetooth Low Energy (BLE) Transport Discovery Service (TDS) frame using an electronic device of FIG. 2 or 3.

FIG. 5 is a flow diagram illustrating an example method for receiving a BLE TDS frame using an electronic device of FIG. 2 or 3.

FIG. 6 is a drawing illustrating an example of communication between the electronic devices of FIG. 2 or 3.

FIG. 7 is a drawing illustrating an example of communication between the electronic devices of FIG. 2 or 3.

FIG. 8 is a drawing illustrating an example of a BLE TDS frame.

FIGS. 9-11 are drawings illustrating examples of Bloom filters.

FIG. 12 is a drawing illustrating examples of communication between the electronic devices of FIG. 2 or 3.

FIGS. 13-16 are drawings illustrating examples of BLE TDS frames.

FIG. 17 illustrates an example of an electronic device of FIG. 1 according to some embodiments of the disclosure.

Note that like reference numerals refer to corresponding parts throughout the drawings. Moreover, multiple instances of the same part are designated by a common prefix separated from an instance number by a dash.

### DETAILED DESCRIPTION

An electronic device is described. During operation, the electronic device can perform neighborhood area network (NAN) pairing with a second electronic device, where, during the NAN pairing, the electronic device and the second electronic device exchange NAN identity keys (NIKs) or trigger identity keys (TIKs). Note that the NAN pairing can convey a BLE trigger capability of the second electronic device to the electronic device. Moreover, the electronic device can provide, addressed to the second electronic device, a Bluetooth Low Energy (BLE) transportation discovery service (TDS) frame, wherein the BLE TDS frame includes an identity tag (ITag) corresponding to packet data in the BLE TDS frame and an NIK of the electronic device or a TIK of the electronic device.

By providing the BLE TDS frame, these communication techniques can facilitate enhanced security and/or privacy, e.g., during Wi-Fi peer-to-peer (P2P) communication. In these ways, the communication techniques can improve the user experience when communicating BLE TDS frames, during Wi-Fi P2P communication and, more generally, when using the electronic device and/or the second electronic device.

In the discussion that follows, a user can include: an individual, an organization, a company, a governmental agency, a for-profit business entity, a not-for-profit entity, or a group of one or more individuals.

Note that the communication techniques can be used during or with wired or wireless communication between electronic devices in accordance with a communication protocol, such as a communication protocol that is compatible with an IEEE 802.11 standard (which is sometimes referred to as Wi-Fi). However, the communication techniques can also be used with a wide variety of other communication protocols, and in electronic devices (such as portable electronic devices or mobile devices) that can incorporate multiple different radio access technologies (RATs) to provide connections through different wireless networks that offer different services and/or capabilities.

The electronic device and/or the second electronic device can include hardware and software to support a wireless personal area network (WPAN) according to a WPAN communication protocol, such as those standardized by the Bluetooth Special Interest Group and/or those developed by Apple (in Cupertino, California) that are referred to as an Apple Wireless Direct Link (AWDL). Moreover, the electronic device and/or the second electronic device can communicate via: a wireless wide area network (WWAN), a wireless metro area network (WMAN), a WLAN, near-field communication (NFC), a cellular-telephone or data network (such as using a third generation (3G) communication protocol, a fourth generation (4G) communication protocol, e.g., Long Term Evolution or LTE, LTE Advanced (LTE-A), a fifth generation (5G) communication protocol, or other present or future developed advanced cellular communication protocol) and/or another communication protocol. In some embodiments, the communication protocol includes a peer-to-peer communication technique.

The electronic device and/or the second electronic device, in some embodiments, can also operate as part of a wireless communication system, which can include a set of client devices, which can also be referred to as stations or client electronic devices, interconnected to an access point, e.g., as part of a WLAN, and/or to each other, e.g., as part of a WPAN and/or an ‘ad hoc’ wireless network, such as a Wi-Fi direct connection. In some embodiments, the client device can be any electronic device that is capable of communicating via a WLAN technology, e.g., in accordance with a WLAN communication protocol. Furthermore, in some embodiments, the WLAN technology can include a Wi-Fi (or more generically a WLAN) wireless communication subsystem or radio, and the Wi-Fi radio can implement an IEEE 802.11 technology, such as one or more of: IEEE 802.11a; IEEE 802.11b; IEEE 802.11g; IEEE 802.11-2007; IEEE 802.11n; IEEE 802.11-2012; IEEE 802.11-2016; IEEE 802.11ac; IEEE 802.11ax, IEEE 802.11ba, IEEE 802.11be, IEEE 802.11me, IEEE 802.11bn, IEEE 802.11bx, IEEE 802.11mf or other present or future developed IEEE 802.11 technologies.

Note that the electronic device and/or the second electronic device can use multi-user transmission (such as OFDMA) and/or multiple-input multiple-output (MIMO).

In some embodiments, the electronic device and/or the second electronic device can act as a communications hub that provides access to a WLAN and/or to a WWAN and, thus, to a wide variety of services that can be supported by various applications executing on the electronic device and/or the second electronic device. Thus, the electronic device and/or the second electronic device can include an ‘access point’ that communicates wirelessly with other electronic devices (such as using Wi-Fi), and that provides access to another network (such as the Internet) via IEEE 802.3 (which is sometimes referred to as ‘Ethernet’). Note that the access point can be a physical access point or a virtual or ‘software’ access point that is implemented on a computer or an electronic device. However, in other embodiments the electronic device and/or the second electronic device may not be an access point.

Additionally, it should be understood that the electronic devices described herein can be configured as multi-mode wireless communication devices that are also capable of communicating via different 3G and/or 2G RATs. In these scenarios, a multi-mode electronic device or UE can be configured to prefer attachment to LTE networks offering faster data rate throughput, as compared to other 3G legacy networks offering lower data rate throughputs. For example, in some implementations, a multi-mode electronic device is configured to fall back to a 3G legacy network, e.g., an Evolved High Speed Packet Access (HSPA+) network or a Code Division Multiple Access (CDMA) 2000 Evolution-Data Only (EV-DO) network, when LTE and LTE-A networks are otherwise unavailable. More generally, the electronic devices described herein can be capable of communicating with other present or future developed cellular-telephone technologies.

In accordance with various embodiments described herein, the terms ‘wireless communication device,’ ‘electronic device,’ ‘mobile device,’ ‘mobile station,’ ‘wireless station,’ ‘wireless access point,’ ‘station,’ ‘access point’ and ‘user equipment’ (UE) can be used herein to describe one or more consumer electronic devices that can be capable of performing procedures associated with various embodiments of the disclosure.

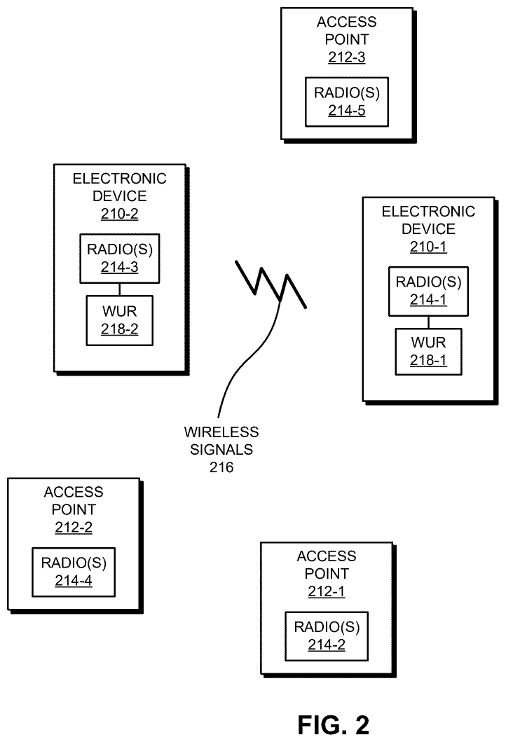

FIG. 2 presents a block diagram illustrating an example of electronic devices communicating wirelessly. Notably, one or more electronic devices 210 (such as a smartphone, a laptop computer, a notebook computer, a tablet, or another such electronic device) and access point 212-1 can communicate wirelessly in a WLAN using an IEEE 802.11 communication protocol. Thus, electronic devices 210 can be associated with or can have one or more connections with access point 212-1. For example, electronic devices 210 and access point 212-1 can wirelessly communicate while: detecting one another by scanning wireless channels, transmitting and receiving beacons or (equivalently) beacon frames on wireless channels, establishing connections (for example, by transmitting connect requests), and/or transmitting and receiving packets or frames (which can include the request and/or additional information, such as data, as payloads). Note that access point 212-1 can provide access to a network, such as the Internet, via an Ethernet protocol, and can be a physical access point or a virtual or ‘software’ access point that is implemented on a computer or an electronic device. In the discussion that follows, electronic devices 210 are sometimes referred to as ‘clients,’ ‘stations,’ or ‘recipient electronic devices.’

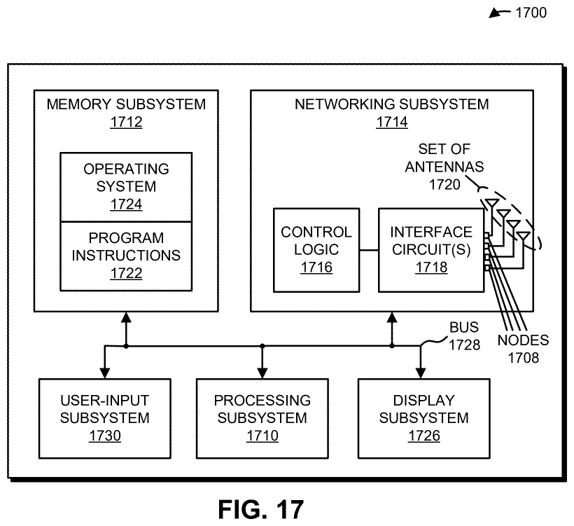

As described further below with reference to FIG. 17, electronic devices 210 and access point 212-1 can include subsystems, such as a networking subsystem, a memory subsystem, and a processor subsystem. In addition, electronic devices 210 and access point 212-1 can include radios 214 in the networking subsystems. More generally, electronic devices 210 and access point 212-1 can include (or can be included within) any electronic devices with networking subsystems that enable electronic devices 210 and access point 212-1, respectively, to wirelessly communicate with another electronic device. This can include transmitting beacon frames on wireless channels to enable the electronic devices to make initial contact with or to detect each other, followed by exchanging subsequent data/management frames (such as connect requests) to establish a connection, configure security options (e.g., IPSec), transmit and receive packets or frames via the connection, etc.

As can be seen in FIG. 2, wireless signals 216 (represented by a jagged line) are communicated by one or more radios 214-1 and 214-3 in electronic device 210-1 and electronic device 210-2, respectively. For example, as noted previously, electronic device 210-1 and electronic device 210-2 can exchange packets or frames using a Wi-Fi communication protocol in a WLAN. As illustrated further below with reference to FIGS. 2-16, one or more radios 214-1 can receive wireless signals 216 that are transmitted by one or more radios 214-3 via one or more links between electronic device 210-1 and electronic device 210-2. Alternatively, the one or more radios 214-1 can transmit wireless signals 216 that are received by the one or more radios 214-3.

In some embodiments, wireless signals 216 are communicated by one or more radios 214 in electronic devices 210 and access point 212-1, respectively. For example, one or more radios 214-1 and 214-3 can receive wireless signals 216 that are transmitted by one or more radios 214-2 via one or more links between electronic devices 210-1 and 210-2, and access point 212-1.

Note that the one or more radios 214-1 can consume additional power in a higher-power mode. If the one or more radios 214-1 remain in the higher-power mode even when they are not transmitting or receiving packets or frames, the power consumption of electronic device 210-1 can be needlessly increased. Consequently, electronic devices 210 can include wake-up radios (WURs) 218 that listen for and/or receive wake-up frames (and/or other wake-up communications), e.g., from access point 212-1. When a particular electronic device (such as electronic device 210-1) receives a wake-up frame, WUR 218-1 can selectively wake-up radio 214-1, e.g., by providing a wake-up signal that selectively transitions at least one of the one or more radios 214-1 from a lower-power mode to the higher-power mode.

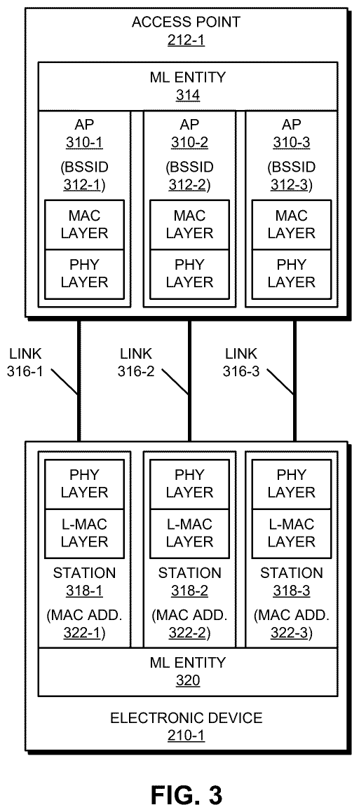

IEEE 802.11be has proposed the use of multiple concurrent links between electronic devices, such as access point 212-1 and one or more of electronic device 210. For example, as shown in FIG. 3, which presents a block diagram illustrating an example of electronic devices communicating wirelessly, access point 212-1 can be an access point multi-link device (MLD) that includes multiple access points 310, which are cohosted or collocated in access point 212-1. In the present discussion, ‘cohosted’ or ‘collocated’ means that access points 310 are physically or virtually implemented in the same access point MLD, or are affiliated with the same access point MLD. Note that this meaning of ‘cohosted’ does not indicate that access points 310 have the same primary 20 MHz channel. Access points 310 can have associated BSSIDs 312, and media access control (MAC) and physical (PHY) layers (including separate radios, which can be included in the same or different integrated circuits). Note that access point 212-1 can have an ML entity 314 having an MLD MAC address, an ML identifier, a service set identifier (SSID), and that can provide security for access points 310.

Moreover, access points 310 can have different concurrent links 316 in different bands of frequencies (such as a link 316-1 with a link identifier 1 in a 2.4 GHz band of frequencies, a link 316-2 with a link identifier 2 in a 5 GHz band of frequencies and a link 316-3 with a link identifier 3 in a 6 GHz bands of frequencies) with stations 318 in at least electronic device 210-1, which is a non-access point MLD. These stations can have associated lower MAC and PHY layers (including separate radios, which can be included in the same or different integrated circuits). In addition, electronic device 210-1 can have an ML entity 320 having an MLD MAC address.

For example, the access point MLD can have three radios. One radio can operate on a 2.4 GHz band of frequencies, and the other radios can operate on the 5/6 GHz bands of frequencies. The access point MLD can create three access points 310, operating on a 2.4 GHz channel, a 5 GHz channel, and a 6 GHz channel respectively. The three access points 310 can operate independently, each of which has at least one BSS with different BSSIDs 312. (While FIG. 3 illustrates the access point MLD with three access points 310, more generally the access point MLD can include up to 15 access points with one or more access points in a given band of frequencies.) Moreover, each of the access points 310 can accommodate both legacy non-access point stations as well as non-access point MLD stations 318. Furthermore, each of access points 310 can transmit its own beacon frames using its own BSSID. Additionally, the access point MLD can have ML entity 314, identified by an MLD address (such as an MLD MAC address). This MAC address can be used to pair with ML entity 320 of the associated non-access point MLD stations 318.

Moreover, the non-access point MLD station (e.g., electronic device 210-1) can have two or three radios. One radio can operate on a 2.4 GHz band of frequencies, and the other radios can operate on the 5/6 GHz bands of frequencies. When the non-access point MLD establishes an ML association with the access point MLD, it can create up to three stations 318, each of which associates to one of access points 310 within the access point MLD. Each of stations 318 can have a different OTA MAC address 322. The non-access point MLD can also have ML entity 320, identified by another MLD address (such as another MLD MAC address). This MLD MAC address can be used to pair with ML entity 314 of the associated access point MLD.

Referring back to FIG. 2, as noted previously, there can be security and/or privacy problems in existing BLE TDS communication. In order to address these problems, as described further below with reference to FIGS. 3-16, in the communication techniques electronic device 210-1 and/or electronic device 210-2 can perform the communication techniques.

Notably, electronic device 210-1 can perform NAN pairing with a second electronic device (such as electronic device 210-2). Note that, during the NAN pairing, electronic device 210-1 and electronic device 210-2 can exchange NIKs or TIKs. Moreover, electronic device 210-1 can provide, addressed to electronic device 210-2, a BLE TDS frame, where the BLE TDS frame includes an ITag corresponding to packet data in the BLE TDS frame and an NIK of electronic device 210-1 and/or a TIK of electronic device 210-1.

Note that the ITag can equal N bits in a hash of the packet data and the NIK or the TIK. For example, the hash can be performed using a SipHash function.

Moreover, the packet data can include all fields in the BLE TDS frame preceding the ITag.

Furthermore, the BLE TDS frame can include a Bloom Filter field with information corresponding to select information elements in a data stream and a timestamp of electronic device 210-1. For example, the timestamp can include a Unix Time of electronic device 210-1. Additionally, the information can correspond to a hash of the select information elements and the timestamp. The hash can be performed using a SipHash function. Alternatively or additionally, the NIK or the TIK can include a key of a hash function that performs the hash. In some embodiments, the information can correspond to a nonce.

Note that the information can correspond to a hash of the select information elements, the timestamp and the nonce, and/or the nonce can be changed in different BLE TDS frames. Moreover, the information can correspond to: a value in an AdvA field in the BLE TDS frame; and/or a hash of the select information elements, the timestamp and the value in the AdvA field. Alternatively or additionally, the value in the AdvA field can be changed in different BLE TDS frames, and/or one or more of the NIK, the TIK and the value of the AdvA field can be used to generate a key of a hash function that performs the hash.

The TIK can include: a random number; or correspond to the NIK. For example, the TIK can include 64 or 128 bits.

Additionally, the BLE TDS frame can include a Bloom Filter field with information corresponding to select information elements in a data stream and the select information elements can be hashed prior to electronic device 210-1 generating the Bloom Filter field based at least in part on hashed values of the select information elements.

In some embodiments, the BLE TDS frame can include a Bloom Filter field with information corresponding to select information elements in a data stream that are randomized in the BLE TDS frame.

Note that the ITag of electronic device 210-1 can include a GITag of a group of electronic devices, a SITag or a DITag.

Moreover, the NIK of the electronic device can include a GNIK of a group of electronic devices. For example, the BLE TDS frame can include a Bloom Filter field with information corresponding to select information elements in a data stream and the GNIK.

Furthermore, the BLE TDS frame can include a TDS header field that indicates one or more of: a length of a Bloom Filter in the BLE TDS frame; a type of ITag present in the BLE TDS frame; whether a timestamp is used to compute a value of the Bloom Filter; and/or whether information elements in a data stream used to compute the value of the Bloom Filter are randomized.

Additionally, the BLE TDS frame can include a header extension field that indicates one or more of: whether the BLE TDS frame comprises a timestamp; a number of ITags included in the BLE TDS frame; and/or types of the one or more ITags.

In some embodiments, the NAN pairing can convey a BLE trigger capability of electronic device 210-2 to electronic device 210-1.

In summary, the disclosed communication techniques can facilitate secure and private communication between electronic device 210-1 and electronic device 210-2. In these ways, the communication techniques can improve the user experience when using electronic device 210-1 and/or electronic device 210-2.

While the preceding discussion illustrated communication by electronic device 210-1 to electronic device 210-2, in other embodiments the roles of electronic device 210-1 and electronic device 210-2 can be reversed in the communication techniques. Alternatively, in some embodiments, the communication techniques are performed between electronic device 210-1 and access point 212-1. For example, electronic device 210-1 can be a station or client that is associated with access point 212-1.

Note that access point 212-1 and one or more electronic devices (such as electronic devices 210-1 and/or 210-2) can be compatible with an IEEE 802.11 standard that includes trigger-based channel access (such as IEEE 802.11ax). However, access point 212-1 and/or the one or more electronic devices can also communicate with one or more legacy electronic devices that are not compatible with the IEEE 802.11 standard (i.e., that do not use multi-user trigger-based channel access). In some embodiments, access point 212-1 and the one or more electronic devices use multi-user transmission (such as OFDMA). For example, the one or more radios 214-2 can provide one or more trigger frames for the one or more electronic devices. Moreover, in response to receiving the one or more trigger frames, the one or more radios 214-1 can provide one or more group or block acknowledgments to the one or more radios 214-2. For example, the one or more radios 214-1 can provide the one or more group acknowledgments during associated assigned time slot(s) and/or in an assigned channel(s) in the one or more group acknowledgments. However, in some embodiments one or more of electronic devices 210 can individually provide acknowledgments to the one or more radios 214-2. Thus, the one or more radios 214-1 (and, more generally, radios 214 in the electronic devices 210-1 and/or 210-2) can provide one or more acknowledgments to the one or more radios 214-2.

In the described embodiments, processing a packet or frame in one of electronic devices 210 or access point 212-1 includes: receiving wireless signals 216 encoding a packet or a frame; decoding/extracting the packet or frame from received wireless signals 216 to acquire the packet or frame; and processing the packet or frame to determine information contained in the packet or frame (such as data in the payload).

In general, the communication via the WLAN in the communication techniques can be characterized by a variety of communication-performance metrics. For example, the communication-performance metric can include one or more of: an RSSI, a data rate, a data rate for successful communication (which is sometimes referred to as a ‘throughput’), a latency, an error rate (such as a retry or resend rate), a mean-square error of equalized signals relative to an equalization target, inter-symbol interference, multipath interference, a signal-to-noise ratio (SNR), a width of an eye pattern, a ratio of a number of bytes successfully communicated during a predetermined or predefined time interval (such as a time interval between, e.g., 1 and 10 s) to an estimated maximum number of bytes that can be communicated in the predetermined or predefined time interval (the latter of which is sometimes referred to as the ‘capacity’ of a communication channel or link), and/or a ratio of an actual data rate to an estimated data rate (which is sometimes referred to as ‘utilization’).

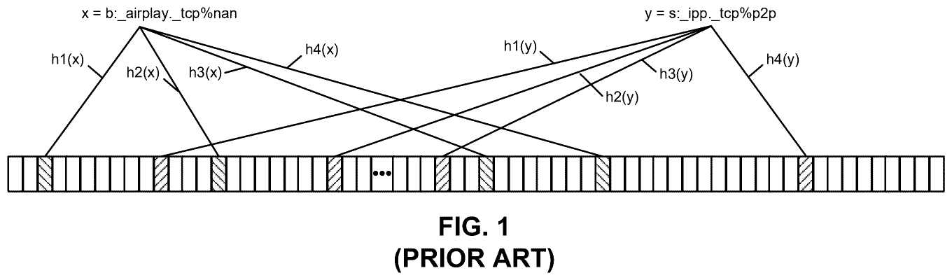

Although we describe the network environment shown in FIG. 1 as an example, in alternative embodiments, different numbers and/or types of electronic devices can be present. For example, some embodiments can include more or fewer electronic devices. As another example, in other embodiments, different electronic devices can be transmitting and/or receiving packets or frames. In some embodiments, multiple links can be used during communication between electronic devices 210. Consequently, one of electronic devices 210 can perform operations in the communication techniques.

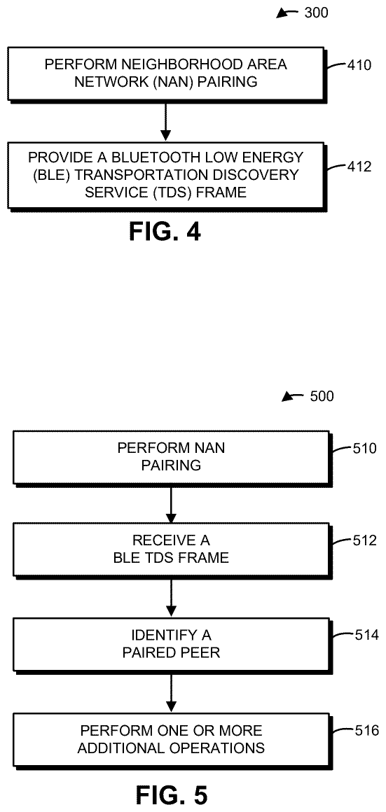

FIG. 4 presents a flow diagram illustrating an example method 400 for providing a BLE TDS frame. This method can be performed by an electronic device, such as electronic device 210-1 in FIG. 2. For example, method 400 can be implemented by an interface circuit in electronic device 210-1 in FIG. 2. Note that the communication between the electronic device and a second electronic device (such as electronic device 210-2 in FIG. 2) can be compatible with an IEEE 802.11 communication protocol.

During operation, the electronic device can perform NAN pairing (operation 410) with a second electronic device. Note that, during the NAN pairing, the electronic device and the second electronic device exchange NIKs or TIKs. Moreover, the electronic device can provide, addressed to the second electronic device, a BLE TDS frame (operation 412), where the BLE TDS frame includes an ITag corresponding to packet data in the BLE TDS frame and an NIK of the electronic device or a TIK of the electronic device.

Note that the ITag can equal N bits in a hash of the packet data and the NIK or the TIK. For example, the hash can be performed using a SipHash function.

Moreover, the packet data can include all fields in the BLE TDS frame preceding the ITag.

Furthermore, the BLE TDS frame can include a Bloom Filter field with information corresponding to select information elements in a data stream and a timestamp of the electronic device. For example, the timestamp can include a Unix Time of the electronic device. Additionally, the information can correspond to a hash of the select information elements and the timestamp. The hash can be performed using a SipHash function. Alternatively or additionally, the NIK or the TIK can include a key of a hash function that performs the hash. In some embodiments, the information can correspond to a nonce.

Note that the information can correspond to a hash of the select information elements, the timestamp and the nonce, and/or the nonce can be changed in different BLE TDS frames. Moreover, the information can correspond to: a value in an AdvA field in the BLE TDS frame; and/or a hash of the select information elements, the timestamp and the value in the AdvA field. Alternatively or additionally, the value in the AdvA field can be changed in different BLE TDS frames, and/or one or more of the NIK, the TIK and the value of the AdvA field can be used to generate a key of a hash function that performs the hash.

The TIK can include: a random number; or correspond to the NIK. For example, the TIK can include 64 or 128 bits.

Additionally, the BLE TDS frame can include a Bloom Filter field with information corresponding to select information elements in a data stream and the select information elements can be hashed prior to the electronic device generating the Bloom Filter field based at least in part on hashed values of the select information elements.

In some embodiments, the BLE TDS frame can include a Bloom Filter field with information corresponding to select information elements in a data stream that are randomized in the BLE TDS frame.

Note that the ITag of the electronic device can include a GITag of a group of electronic devices, a SITag or a DITag.

Moreover, the NIK of the electronic device can include a GNIK of a group of electronic devices. For example, the BLE TDS frame can include a Bloom Filter field with information corresponding to select information elements in a data stream and the GNIK.

Furthermore, the BLE TDS frame can include a TDS header field that indicates one or more of: a length of a Bloom Filter in the BLE TDS frame; a type of ITag present in the BLE TDS frame; whether a timestamp is used to compute a value of the Bloom Filter; and/or whether information elements in a data stream used to compute the value of the Bloom Filter are randomized.

Additionally, the BLE TDS frame can include a header extension field that indicates one or more of: whether the BLE TDS frame comprises a timestamp; a number of ITags included in the BLE TDS frame; and/or types of the one or more ITags.

In some embodiments, the NAN pairing can convey a BLE trigger capability of the second electronic device to the electronic device.

FIG. 5 presents a flow diagram illustrating an example method 500 for receiving a BLE TDS frame. This method can be performed by a second electronic device, such as electronic device 210-2 in FIG. 2. For example, method 500 can be implemented by an interface circuit in electronic device 210-2 in FIG. 2. Note that the communication between the second electronic device and an electronic device (such as electronic device 210-1 in FIG. 2) can be compatible with an IEEE 802.11 communication protocol.

During operation, the second electronic device can perform NAN pairing (operation 510) with an electronic device. Note that, during the NAN pairing, the electronic device and the second electronic device can exchange NIKs or TIKs. Moreover, the second electronic device can receive, associated with the electronic device, a BLE TDS frame (operation 512), where the BLE TDS frame includes an ITag corresponding to packet data in the BLE TDS frame and an NIK of the electronic device or a TIK of the electronic device. Furthermore, the second electronic device can identify a paired peer (operation 514) based at least in part on the ITag and the NIK or the TIK of the electronic device.

Note that the identifying (operation 514) can include: generating one or more ITag values based at least in part on the packet data in the received BLE TDS frame and a stored value of the NIKs of paired third electronic devices; comparing the one or more generated ITag values with the ITag value in the BLE TDS frame; and when a match occurs, identifying the paired peer as the second electronic device.

Moreover, the ITag can equal N bits in a hash of the packet data and the NIK or the TIK. For example, the hash can be performed using a SipHash function. Alternatively or additionally, the packet data can include all fields in the received BLE TDS frame preceding the ITag.

In some embodiments, the second electronic device optionally performs one or more additional operations (operation 516). For example, the second electronic device can identify a matched service based at least in part on a value of a Bloom Filter in the BLE TDS frame.

In some embodiments of methods 400 (FIG. 4), and/or 500, there can be additional or fewer operations. Further, one or more different operations can be included. Moreover, the order of the operations can be changed, and/or two or more operations can be combined into a single operation or performed at least partially in parallel.

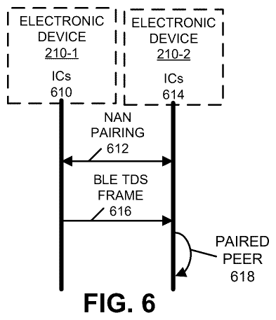

The communication techniques are further illustrated in FIG. 6, which presents a flow diagram illustrating an example of communication between electronic device 210-1 and electronic device 210-2. During operation, one or more interface circuits (or interface circuitry) 610 in electronic device 210-1 can perform NAN pairing 612 with one or more interface circuits (or interface circuitry) 614 in electronic device 210-2. Note that, during the NAN pairing, electronic device 210-1 and electronic device 210-2 can exchange NIKs or TIKs. Note that NAN pairing 612 can convey a BLE trigger capability of electronic device 210-2 to electronic device 210-1 (or vice versa).

Moreover, the one or more interface circuits 610 in electronic device 210-1 can provide, addressed to electronic device 210-2, a BLE TDS frame 616, where BLE TDS frame 616 includes an ITag corresponding to packet data in the BLE TDS frame and an NIK of electronic device 210-1 and/or a TIK of electronic device 210-1.

Furthermore, the one or more interface circuits 614 can receive, associated with electronic device 210-1, BLE TDS frame 616. Additionally, the one or more interface circuits 614 can identify a paired peer 618 based at least in part on the ITag and the NIK and/or the TIK of electronic device 210-1.

While communication between the components in FIG. 6 are illustrated with unilateral or bilateral communication (e.g., lines having a single arrow or dual arrows), in general a given communication operation can be unilateral or bilateral. Moreover, while operations in FIG. 6 are illustrated as being sequential, in some embodiments at least some of the operations can be performed in parallel.

We now further describe embodiments of the disclosed communication techniques. As discussed previously, there can be security and/or privacy problems during communication of a BLE TDS frame. These challenges can be addressed using the disclosed communication techniques.

Notably, some of the motivation of the disclosed communication techniques include that a subscriber can be launched at NAN and/or BLE to discover a set of publishers that are offering services to which the subscriber may be interested. The subscriber can restrict discovery of publishers to those offering specific service(s). Moreover, the subscriber can restrict discovery of publishers to those that are known paired electronic devices. The subscriber can also allow discovery of all electronic devices regardless of whether they are paired. Furthermore, the subscriber can trigger one or multiple publishers to invoke full NAN service discovery to confirm the publisher(s) are of interest.

A publisher can configure its BLE to scan for triggers from subscribers for one or multiple services supported by the publisher. The publisher can accept triggers only from known paired electronic devices. Moreover, the publisher can also allow triggers from any electronic devices regardless of whether they are paired. Upon receiving a matched BLE trigger, the publisher can invoke NAN for full service discovery. A subscriber should be able to identify itself and provide service information to paired publishers via secured and privacy conservation techniques. Note that a subscriber can have multiple active user accounts, each with a different identity.

Thus, in some embodiments, BLE TDS can provide a way to enable a subscriber to only wake up a subset of electronic devices using a one-way BLE TDS from the subscriber. Consequently, the subscribed may not wake up all electronic devices. Instead, wake up can be based at least in part on a pairing relationship. Additionally, in other embodiments, there can be a two-way or a three-way handshake. For example, a publisher can publish a service via a BLE TDS and a subscriber can select the publisher to turn on a NAN interface of the subscriber. Alternatively, a subscriber can seek a service via BLE TDS. Then, a publisher can publish a service via a BLE TDS and the subscriber can select the publisher to turn on a NAN interface of the subscriber.

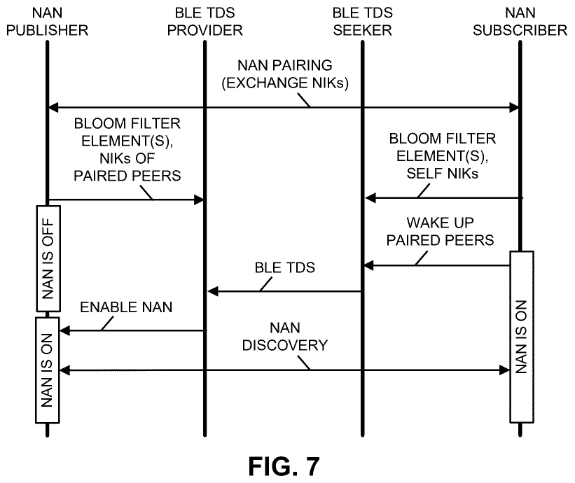

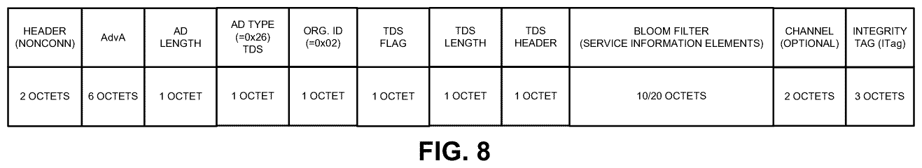

In order to facilitate these and other capabilities, the disclosed communication techniques can provide security and/or privacy enhancements to BLE TDS. FIG. 7 presents a drawing illustrating an example of communication between the electronic devices of FIG. 2 or 3. Moreover, FIG. 8 presents a drawing illustrating an example of a BLE TDS frame.

As shown in FIG. 8, security can be enhanced by including electronic-device identity and/or integrity protection in a BLE TDS frame. Notably, a BLE TDS frame can include an integrity tag after the optional channel information. The integrity tag (ITag) can be the first three bytes of SipHash (NIK, <packet data>), where NIK is the NAN identity key of the transmitter, and <packet data> can include all fields in a BLE TDS frame except for the ITag field (such as from the header field to the field immediately before the ITag field).

In receiver-side processing, a Bloom Filter can first be checked for a matched service. When a matched service is found, attempt ITag values can be generated from: the <packet data> of received BLE TDS frame and stored NIKs of paired peers. The attempted ITag values can be compared with the value of the ITag field in the received BLE TDS frame. When a matched ITag is found, the paired peer is identified and the integrity check is completed.

In some embodiments, a NAN publisher and a NAN subscriber can perform NAN pairing to exchange one or more NAN identity keys (NIKs). After that, the NAN publisher can provide Bloom Filter element(s) corresponding to the advertised service(s), as well as NIKs of paired peers to the BLE TDS provider, and the NAN subscriber can provide Bloom Filter element(s) corresponding to the sought service(s), as well as its own NIK, to the BLE TDS seeker.

While the NAN of the NAN publisher(s) is off and the NAN of the NAN subscriber is on, the NAN subscriber can wake up the NAN interface of paired publishers for full service discovery. To achieve this purpose, the BLE TDS seeker can transmit a BLE TDS frame to the electronic devices in the neighborhood. Some of the receiving devices are NAN publishers which are paired with the NAN subscriber (collocated with the BLE TDS seeker). This BLE TDS frame can include an ITag. Note that the NAN subscriber or the collocated BLE TDS seeker can generate the ITag, and the NAN publisher or the collocated BLE TDS provider can verify the ITag (and, thus, the BLE TDS frame) based at least in part on the NIK of the NAN subscriber (which was previously provided by the NAN subscriber to the NAN publisher during the pairing).

When a service matched paired peer is found when the ITag is checked, the BLE TDS provider can enable the NAN of the NAN publisher. Then, the NAN publisher and the NAN subscriber can perform NAN discovery. Note that the ITag can provide integrity protection for the payload in a BLE TDS frame, thereby protecting the content of a Bloom Filter.

Moreover, the disclosed communication techniques can provide replay attack protection. Notably, a problem is that a BLE TDS frame with an ITag can be replayed by a malicious electronic device, e.g., to poke around paired peers of the original transmitter of the BLE TDS frame. In the disclosed communication techniques, this can be addressed by having the transmitter of a BLE TDS frame hash a current timestamp (such as its UnixTime timestamp) as an element into the Bloom Filter (in conjunction with the service elements). The Unix Time timestamp can be included in the Bloom Filter in the BLE TDS frame provided by the BLE TDS seeker to the BLE TDS provider. In some embodiments, 32 bits UnixTime can be converted to 64 bits random hash from SipHash (UnixTime, fixed key=‘00 00 00 00 00 00 00 00 00 00 00 00 00 00 00 01’). The random_hash can then be used to derive the four-bit indexes for the Bloom Filter like other service elements.

Alternatively, when the Bloom Filter size is 10 octets, a UnixTime timestamp (e.g., 4 octets) can be included as a field in the BLE TDS frame. When receiving the BLE TDS frame, the intended receiver(s) can check its (their) locally maintained UnixTime timestamp(s) against the received timestamp in the BLE TDS frame to avoid replay attack. In order to accommodate the clock drifts between the UnixTime timestamps of a transmitter and receiver(s), a low resolution timestamp (e.g., with a two hour interval) can be used.

Moreover, the disclosed communication techniques can include key optimization. Notably, in some embodiments, the key used in the BLE TDS frame can be separate from the NIK (which is used by the NAN publisher and the NAN subscriber to identify each other in a privacy preserving approach). Moreover, a shorter key (than the NIK) can be used to alleviate the storage burden associated with the Bluetooth firmware. For example, a new key, the TIK (Trigger Identity Key), can be generated for BLE TDS usage. In some embodiments, the integrity tag (ITag) can be generated as the first three bytes of SipHash (TIK, <packet data>). Note that the TIK size can be 64 (to save storage) or 128 bits.

In some embodiments, the TIK can be a random number generated together with the NIK. When the paired peer supports BLE TDS, the TIK can be conveyed to a paired peer together with the NIK. Alternatively, in other embodiments, the TIK can be derived from NIK. For example, the TIK can equal a truncate-128 (KDF-HASH-256 (NIK, ‘Trigger Identity Key’, 0)), KDF is a key derivation function, or the TIK can equal a Truncate-64 (KDF-HASH-256 (NIK, ‘Trigger Identity Key’, 0)). Because SipHash needs a 128-bit key, when TIK is a 64-bit short key, HalfSipHash-2-4-64 can be used, which takes 64-bit key and generates 64-bit hash output. Alternatively, in some embodiments, SipHash Key (128 bits) can equal HKDF-Expand (TIK, ‘SipHash Key’, 128), where HKDF is a KDF that uses a hash function. In other embodiments, SipHash Key (128 bits) can equal TIK∥0x0000000000000000.

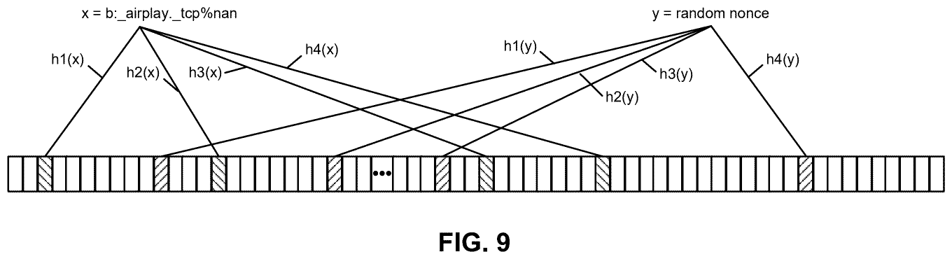

FIG. 9 presents a drawing illustrating an example of a Bloom filter. Notably, in the disclosed communication techniques, in the privacy enhancements the Bloom Filter can be hashed with a random nonce (which can be changed periodically). Thus, the Bloom Filter can include or incorporate service information, a timestamp and/or a random nonce. (Consequently, in these embodiments, the Bloom filter in the BLE TDS frame can correspond to service information, a timestamp and a random nonce.) This can provide privacy conservation. In some embodiments, one or more random nonces can be hashed into the Bloom Filter of each BLE TDS frame. This can result in different random bits being added into the Bloom Filters of different BLE TDS frames. This approach can provide protection against the tracking of whole Bloom Filter bit patterns. However, it may not prevent the tracking of an individual service information element hashed into the Bloom Filter.

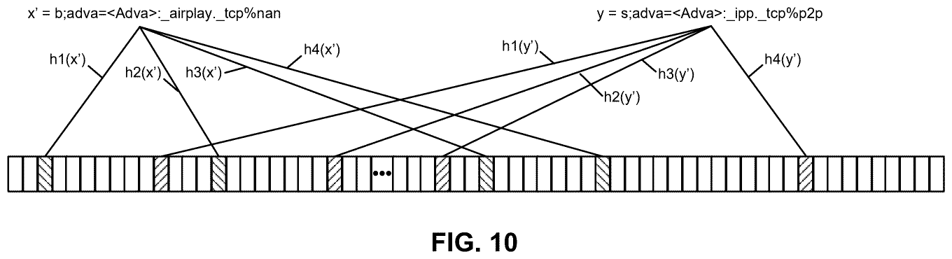

Alternatively or additionally, in some embodiments, privacy conservation can be facilitated using randomized service information in a Bloom filter (in conjunction with a timestamp). This is shown in FIG. 10, which presents a drawing illustrating an example of a Bloom filter. Notably, in some Bloom Filter privacy conservation techniques, an address field, such as an AdvA field (e.g., six octets), can be included in a BLE TDS frame following the header and before the AD length. This may be separate from or in addition to the use of randomized service information and/or an ITag. In some embodiments, the AdvA field can be changed to “random Address,’ which can be used for randomizing service information and/or an ITag.

For example, one way to rotate the service information element(s) in a Bloom Filter is to add AdvA (BLE media access control or MAC address) to the element(s). Notably, AdvA can be added as operation parameter to the element, such as x′=b;adva=<AdvA>:_airplay._tcp%nan. As specified in the Wi-Fi Aware standard specification, b is an operation of browsing for a service and requesting activation of the data link when there is a match, ‘_airplay._tcp’ is a service name and ‘nan’ is a <data link identifier>. Moreover, ‘adva=<AdvA>’ is a parameter string in the disclosed communication techniques that indicates the BLE MAC address of the transmitter in the AdvA field. Furthermore, with the privacy enhancement to randomize serve element(s) in the Bloom Filter, x′=b;_airplay._tcp%nan indicates random_hash=SpiHash(kr,x′), where kr equals TIK and x′ equals the static hash of AdvA to generate four-bit indexes so that the Bloom Filter has a randomized service element hash. (Consequently, in these embodiments, the Bloom filter in the BLE TDS frame can correspond to randomized service information and a timestamp.) Note that AdvA (the Bluetooth MAC address) can be changed periodically, so whenever AdvA is changed, the element string is also changed, which leads to a different four-point set of elements in the Bloom Filter. Alternatively, AdvA can also serve as the key of the SipHash, which is used to hash the service information element into the Bloom Filter. However, because an attacker can acquire the AdvA from the BLE TDS frame, when the attacker is also aware of the original element strings, it can still derive the matching four-bit index set(s) of elements in the Bloom Filter.

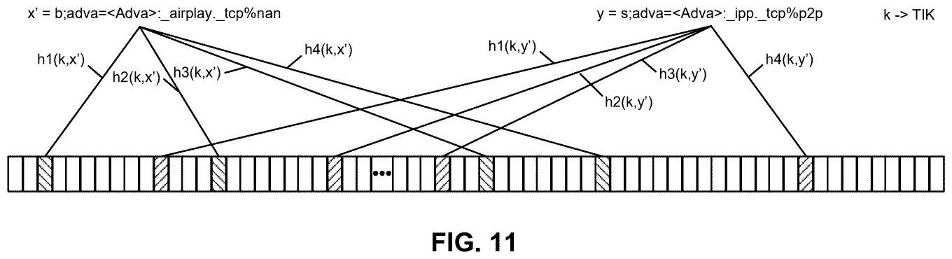

Another embodiment of privacy enhancement based at least in part on randomized service information is shown in FIG. 11, which presents a drawing illustrating an example of a Bloom filter. Notably, in other Bloom Filter privacy conservation techniques, in order to make service information element(s) rotatable (e.g. by adding AdvA), but resolvable only by paired peers, NIK or TIK can be used as the key of the SipHash for generating the Bloom Filter. Note that, the existing BLE TDS solution uses SipHash with a fixed key of ‘00 00 00 00 00 00 00 00 00 00 00 00 00 00 00 01’ to hash the service information element(s) into the Bloom Filter. Alternatively, NIK (or TIK) and AdvA can be used to generate the SipHash key. In some embodiments, while AdvA can be changed periodically (or from time to time), the NIK or TIK may not be changed. Because the NIK or TIK is known only to the NAN publisher and the NAN subscriber, this approach can protect the four-bit index set(s) of elements in the Bloom Filter.

Additionally, the privacy conservation techniques can be optimized for privacy while limiting the storage requirements. Notably, a BLE TDS receiver may need to pass service element strings to the Bluetooth firmware to generate the four-bit index set(s) of elements in the Bloom Filter. For example, the service element can be the <operation>[;<parameters]:<service name>%<data link identifier>. However, the strings can be very long, especially the <service name> can be up to 255 B. In order to address this problem, the service element can be compressed to alleviate the storage burden associated with the Bluetooth firmware.

For example, the service element strings can be hashed to limited size. Notably, SipHash the service element strings to an 8 B compressed element (static_hash) using a fixed key (such as ‘00 00 00 00 00 00 00 00 00 00 00 00 00 00 00 01’). When the service element is not randomized, the compressed element (static_hash) can be directly used to derive the four-bit indexes for the Bloom Filter (same as the operations described previously). Alternatively, when the service element needs to be randomized, the compressed element (static_hash) can be hashed again (e.g., using SipHash) to generate a second hash (random_hash). The random_hash is then used to derive the four-bit indexes for the Bloom Filter.

The random_hash can be generated by one or more SipHash options. In a first option, the SipHash (or HalfSipHash-2-4-64) input equals ‘static_hash∥AdvA’, and the SipHash key is set to NIK or TIK. Moreover, in a second option, the SipHash input equals static_hash, and the SipHash key is padded or expanded from TIK and AdvA. For example, SipHash Key (128 bits) equals TIK∥AdvA∥0x0000 or SipHash Key (128 bits) equals HKDF-Expand (TIK, AdvA, 128).

When a BLE TDS seeker includes ITag, timestamp, and randomized service element(s) in a BLE TDS frame, it can prepare for the BLE TDS frame according to at least one or more of the following operations:
1) Get Bloom Filter service element strings from a NAN subscriber.
2) Get source (transmitter) TIK from the NAN (Wi-Fi).
3) Generate a static_hash for the UnixTime timestamp.
4) Generate four bit-indexes from the static_hash (timestamp) and add them to the Bloom Filter.
5) Generate the static_hash for the reach service element.
6) Generate the random_hash for each static_hash.
7) Generate four bit-indexes from each random_hash and add them to the Bloom Filter.
8) Assemble the <packet data>.
9) Generate an ITag from the TIK and the <packet data>.
10) Generate the BLE TDS frame.
11) When AdvA is changed, regenerate the BLE TDS frame by repeating operations 6-10.
12) When the UnixTime timestamp changes, regenerate the BLE TDS frame by repeating operations 3, 4, 8, 9 and 10.

A BLE TDS provider can prepare for the reception of BLE TDS frames by getting matching service elements or corresponding static_hash(s) from the NAN Publisher. It can then store the static_hash(s) in the Bluetooth module, and can scan for the BLE TDS frames.

For each received BLE TDS frame, the BLE TDS provider can perform at least one of the following operations:
1) Generate validation ITag values by attempting each stored TIK (from paired peers), and compare with the received ITag,
2) When a matched TIK is found,
a) Generate matching random_hash(s) based at least in part on stored static_hash(s), a received AdvA, and the resolved TIK; and
b) Generate four bit-indexes from each matching random_hash, and check them against the received Bloom Filter.
3) When a service match is found,
a) Generate a static_hash and four bit-indexes based at least in part on a current UnixTime timestamp; and
b) Check against the received Bloom Filter to verify the timestamp match.

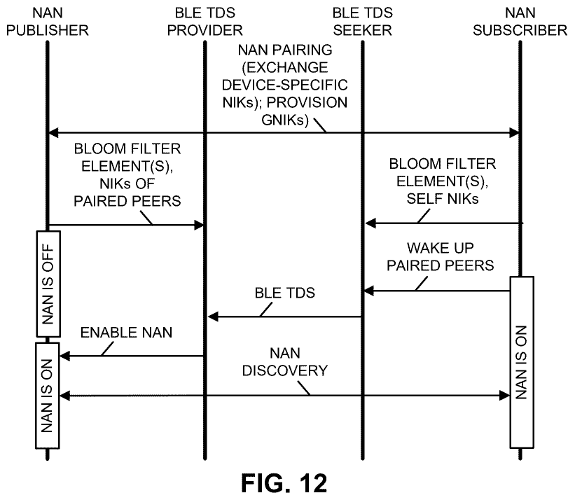

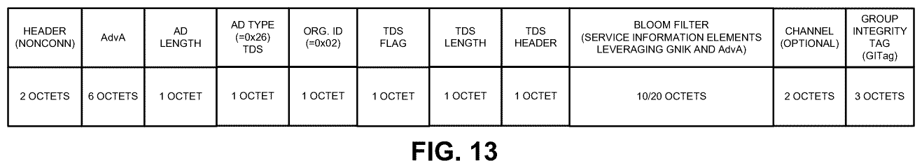

We now describe some ITag options in the communication techniques. FIG. 12 presents a drawing illustrating examples of communication between the electronic devices of FIG. 2 or 3. Moreover, FIG. 13 presents a drawing illustrating an example of a BLE TDS frame.

As shown in FIG. 12, in some embodiments a group ITag can be used instead of an ITag calculated based at least in part on an NIK or TIK of a transmitter. Notably, a group of electronic devices (e.g., some or all of the electronic devices in a home) can share one or multiple GNIKs (Group NIKs) or GTIKs (Group TIKs). A GNIK or GTIK can be used to generate a Group ITag (GITag) for BLE TDS frames transmitted by any member of the group. A GNIK or GTIK can also serve as the key of the SipHash, which is used to randomize the service information element(s) when hashing them into the Bloom Filter.

Moreover, as shown in FIG. 13, in a BLE TDS frame, a GITag (e.g., three octets) can be included following the optional channel field. The Bloom Filter can use randomized service information leveraging a GNIK and the AdvA. During the NAN pairing, the NAN publisher and the NAN subscriber can provision one or more GNIKs. Then, when a BLE TDS seeker provides a BLE TDS frame to a BLE TDS provider, the BLE TDS provider can check the GITag. When a service matched paired peer is found when the GITag is checked, the BLE TDS provider can enable the NAN of the NAN publisher.

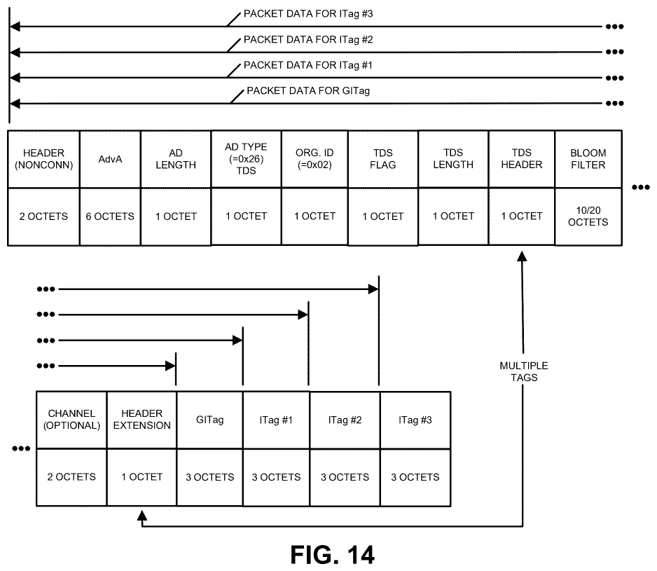

As shown in FIG. 14, which presents a drawing illustrating an example of a BLE TDS frame, in some embodiments multiple identity and integrity tags can be used in a BLE TDS frame. Notably, the BLE TDS frame can include a header extension (e.g., one octet) following the optional channel field. Then, the BLE TDS frame can include a GITag, and one or more ITags. In these embodiments, the GITag or a given ITag can use the preceding fields in the BLE TDS frame as the packet data.

For example, there can be multiple identity tags when: an electronic device needs to support multiple active user accounts (each having its own NIK or TIK); when a 20-octet Bloom Filter is needed, the electronic device may need to send multiple BLE TDS frames, each covering one ITag; when the Bloom Filter size can be limited to 10 octets, the electronic device can include up to 4 ITags in a single BLE TDS frame; a BLE TDS frame includes multiple ITags, and all active accounts share the same GNIK, the GNIK can be used as the key of the SipHash for the Bloom Filter; and/or a GITag can be included in the BLE TDS frames to enable intended receivers to resolve the GNIK. Note that the <packet data> used to calculate a given ITag starts from the header field and ends at the field immediately before the given ITag.

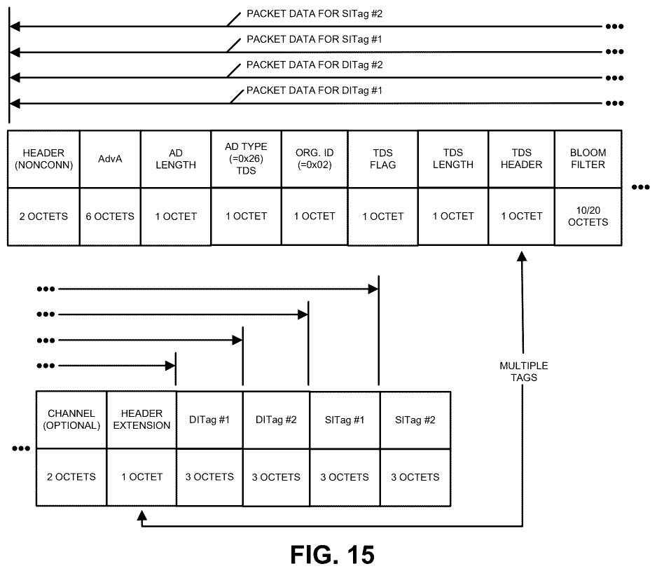

Moreover, in some embodiments there can be SITags and DITags (which each can include three octets in a BLE TDS frame). This is shown in FIG. 15, which presents a drawing illustrating an example of a BLE TDS frame. This capability allows a BLE TDS seeker to trigger a specific BLE TDS provider.

For example, an electronic device can include one or multiple DITag(s) in BLE TDS frames, when the electronic device intends to trigger specific peer(s) to turn on NAN. A DITag can equal the first three bytes of SipHash (destNIK, <packet data>). The destination NIK (destNIK) can be the NIK of the destined peer. In some embodiments, the destination TIK (destTIK) of the destined peer can be used instead. An electronic device can also include both DITag(s) and source ITag(s) in BLE TDS frames, so that a destined peer can resolve: the DITag to reveal itself as the trigger target; and/or the source ITag (SITag) to learn which electronic device sends the trigger. Note that the <packet data> used to calculate a given ITag starts from the header field and ends at the field immediately before the given ITag.

Furthermore, Table I illustrates SITag, DITag and GITag combinations that can be used in a BLE TDS frame as specified by bits 2 and 3 in the header extension.

TABLE I

| Bit Value | ITag #1 | ITag #2 | ITag #3 | ITag #4 |
|---|---|---|---|---|
| ‘0’ | SITag | SITag | SITag | SITag |
| ‘1’ | DITag/GITag | SITag | SITag | SITag |
| ‘2’ | DITag/GITag | DITag/GITag | SITag | SITag |
| ‘3’ | DITag/GITag | DITag/GITag | DITag/GITag | SITag |

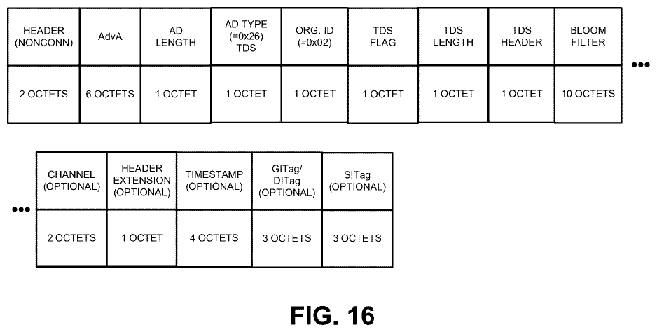

As shown in FIG. 16, which presents a drawing illustrating an example of a BLE TDS frame, in some embodiments there can be a BLE TDS header and/or a header extension. Notably, in the TDS header: bit 0 can specify the Bloom Filter length (e.g., a ‘0’ can specify a length of 10 B and a ‘1’ can specify a length of 20 B); bit 1 can specify trigger de-activation (e.g., a ‘0’ can specify that a trigger is activated and a ‘1’ can specify that a trigger is de-activated); bits 2 and 3 can specify that an ITag is present (e.g., a ‘0’ can specify that no ITag is present, a ‘1’ can specify that an SITag is present, a ‘2’ can specify that a DITag or a GITag is present, a ‘3’ can specify that the TDS header extension field is present when the Bloom Filter length is 10 B, and otherwise the value can be reserved); bit 4 can specify whether a timestamp is present in the Bloom Filter (e.g., a ‘O’ can specify that the timestamp is not present in the Bloom Filter and a ‘1’ can specify that the timestamp is present in the Bloom Filter); bit 6 can specify whether service element randomization is used (e.g., a ‘0’ can specify that a service element in the Bloom Filter is not randomized and a ‘1’ can specify that the service element in the Bloom Filter is randomized when an ITag is present; bit 6 can be reserved; and bit 7 can indicate whether channel information is present (e.g., a ‘0’ can specify that the channel information field is not present and a ‘1’ can specify that the channel information field is present.

Moreover, in the header extension: bit 0 can indicate whether the timestamp is present (e.g., a ‘0 can indicate the timestamp is not present and a ‘1’ can specify that the timestamp is present); bits 1-2 can indicate a number of ITags (e.g., a ‘0’ can indicate one ITag, a ‘1’ can indicate two ITags, a ‘3’ indicate three ITags, and a ‘4’ indicate four ITags); bits 3-4 can indicate an ITag presence sequence (see, e.g., the discussion of Table I); bits 5-7 may be reserved.

Note that, in some embodiments, a BLE TDS frame includes an optional timestamp (e.g., four octets) after an optional header extension (e.g., one octet) and before a GITag. A DITag or a SITag.

Moreover, in some embodiments the BLE TDS frame can include a BLE TDS trigger capability, which can enable an electronic device to communicate during Wi-Fi discovery. Notably, in a BLE trigger capability attribute in a BLE TDS frame: an attribute identifier (ID) field can have a size of one octet and can identify a type of NAN attribute; a length field can have a size of two octets, variable values and can specify the length of subsequent fields in the attribute; and a BTC information field can have variable length and variable values.

Furthermore, the BTC information field can include: bits 0-1 that specify the BLE TDS transmitter and receiver support (e.g., a ‘0’ can indicate reserved, a ‘1’ can indicate support for BLE TDS transmission only, a ‘2’ can indicate support for BLE TDS reception only, and a ‘3’ can indicate support for BLE TDS transmission and reception); bit 2 that specifies ITag support (e.g., a ‘0’ can indicate a lack of support for ITag reception and a ‘1’ can indicate support for ITag reception); bit 3 that specifies timestamp support (e.g., a ‘0’ can indicate a lack of support for a timestamp replay check and a ‘1’ can indicate support for a timestamp replay check); bit 4 that specifies randomized service element support (e.g., a ‘0’ can indicate a lack of support for reception of a randomized service element and a ‘1’ can indicate support for reception of a randomized service element); and subsequent bits may be reserved.

In some embodiments, the communication techniques can be implemented in a physical layer and/or a MAC layer.

Note that the formats of packets or frames communicated during the communication techniques can include more or fewer bits, subfields or fields. Alternatively or additionally, the position of information in these packets or frames can be changed. Thus, the order of the subfields or fields can be changed.

While the preceding embodiments illustrate embodiments of the communication techniques using frequency subbands, in other embodiments the communication techniques can involve the concurrent use of different temporal slots, and/or a combination of different frequency subbands, different frequency bands and/or different temporal slots. In some embodiments, the communication techniques can use OFDMA.

Moreover, while the preceding embodiments illustrated the use of Wi-Fi during the communication techniques, in other embodiments of the communication techniques Bluetooth or Bluetooth Low Energy is used to communicate at least a portion of the information in the communication techniques. Furthermore, the information communicated in the communication techniques can be communicated or can occur in one or more frequency bands, including: 900 MHz, a 2.4 GHz frequency band, a 5 GHz frequency band, a 6 GHz frequency band, a 60 GHZ frequency band, a Citizens Broadband Radio Service (CBRS) frequency band, a band of frequencies used by LTE or another data communication protocol, etc.

As described herein, aspects of the present technology can include the gathering and use of data available from various sources, e.g., to improve or enhance functionality. The present disclosure contemplates that in some instances, this gathered data can include personal information data that uniquely identifies or can be used to contact or locate a specific person. Such personal information data can include demographic data, location-based data, telephone numbers, email addresses, Twitter ID's, home addresses, data or records relating to a user's health or level of fitness (e.g., vital signs measurements, medication information, exercise information), date of birth, or any other identifying or personal information. The present disclosure recognizes that the use of such personal information data, in the present technology, can be used to the benefit of users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data can be governed by federal and/or state laws, such as the Health Insurance Portability and Accountability Act (HIPAA); whereas health data in other countries can be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configurable to allow users to selectively “opt in” or “opt out” of participation in the collection of personal information data, e.g., during registration for services or anytime thereafter. In addition to providing “opt in” and “opt out” options, the present disclosure contemplates providing notifications relating to the access or use of personal information. For instance, a user can be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification can be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure can broadly cover use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

We now describe embodiments of an electronic device. FIG. 17 presents a block diagram of an electronic device 1700 (which can be a cellular telephone, a smartwatch, an access point, a wireless speaker, an IoT device, another electronic device, etc.) in accordance with some embodiments. This electronic device includes processing subsystem 1710, memory subsystem 1712 and networking subsystem 1714. Processing subsystem 1710 includes one or more devices configured to perform computational operations. For example, processing subsystem 1710 can include one or more microprocessors, application-specific integrated circuits (ASICs), microcontrollers, graphics processing units (GPUs), programmable-logic devices, and/or one or more digital signal processors (DSPs). In some embodiments, processing subsystem 1710 can include an interface circuit and a computation circuit.

Memory subsystem 1712 includes one or more devices for storing data and/or instructions for processing subsystem 1710, and/or networking subsystem 1714. For example, memory subsystem 1712 can include dynamic random access memory (DRAM), static random access memory (SRAM), a read-only memory (ROM), flash memory, and/or other types of memory. In some embodiments, instructions for processing subsystem 1710 in memory subsystem 1712 include: program instructions or sets of instructions (such as program instructions 1722 or operating system 1724), which can be executed by processing subsystem 1710. For example, a ROM can store programs, utilities or processes to be executed in a non-volatile manner, and DRAM can provide volatile data storage, and can store instructions related to the operation of electronic device 1700. Note that the one or more computer programs can constitute a computer-program mechanism, a computer-readable storage medium or software. Moreover, instructions in the various modules in memory subsystem 1712 can be implemented in: a high-level procedural language, an object-oriented programming language, and/or in an assembly or machine language. Furthermore, the programming language can be compiled or interpreted, e.g., configurable or configured (which can be used interchangeably in this discussion), to be executed by processing subsystem 1710. In some embodiments, the one or more computer programs are distributed over a network-coupled computer system so that the one or more computer programs are stored and executed in a distributed manner.

In addition, memory subsystem 1712 can include mechanisms for controlling access to the memory. In some embodiments, memory subsystem 1712 includes a memory hierarchy that includes one or more caches coupled to a memory in electronic device 1700. In some of these embodiments, one or more of the caches is located in processing subsystem 1710.

In some embodiments, memory subsystem 1712 is coupled to one or more high-capacity mass-storage devices (not shown). For example, memory subsystem 1712 can be coupled to a magnetic or optical drive, a solid-state drive, or another type of mass-storage device. In these embodiments, memory subsystem 1712 can be used by electronic device 1700 as fast-access storage for often-used data, while the mass-storage device is used to store less frequently used data.

Networking subsystem 1714 includes one or more devices configured to couple to and communicate on a wired and/or wireless network (i.e., to perform network operations), such as: control logic 1716, one or more interface circuits (or interface circuitry) 1718 and a set of antennas 1720 (or antenna elements) in an adaptive array that can be selectively turned on and/or off by control logic 1716 to create a variety of optional antenna patterns or ‘beam patterns.’ Alternatively, instead of the set of antennas, in some embodiments electronic device 1700 includes one or more nodes 1708, e.g., a pad or a connector, which can be coupled to the set of antennas 1720. Thus, electronic device 1700 may or may not include the set of antennas 1720. For example, networking subsystem 1714 can include a Bluetooth™ networking system, a cellular networking system (e.g., a 3G/4G/5G network such as UMTS, LTE, etc.), a universal serial bus (USB) networking system, a networking system based on the standards described in IEEE 802.12 (e.g., a Wi-Fi® networking system), an Ethernet networking system, and/or another networking system.

In some embodiments, networking subsystem 1714 includes one or more radios, such as a wake-up radio that is used to receive wake-up frames and wake-up beacons, and a main radio that is used to transmit and/or receive frames or packets during a normal operation mode. The wake-up radio and the main radio can be implemented separately (such as using discrete components or separate integrated circuits) or in a common integrated circuit.

Networking subsystem 1714 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 1700 can use the mechanisms in networking subsystem 1714 for performing simple wireless communication between the electronic devices, e.g., transmitting advertising or frame frames and/or scanning for advertising frames transmitted by other electronic devices.

Within electronic device 1700, processing subsystem 1710, memory subsystem 1712 and networking subsystem 1714 are coupled together using bus 1728 that facilitates data transfer between these components. Bus 1728 can include an electrical, optical, and/or electro-optical connection that the subsystems can use to communicate commands and data among one another. Although only one bus 1728 is shown for clarity, different embodiments can include a different number or configuration of electrical, optical, and/or electro-optical connections among the subsystems.

In some embodiments, electronic device 1700 includes a display subsystem 1726 for displaying information on a display, which can include a display driver and the display, such as a liquid-crystal display, a multi-touch touchscreen, etc. Display subsystem 1726 can be controlled by processing subsystem 1710 to display information to a user (e.g., information relating to incoming, outgoing, or an active communication session).

Moreover, electronic device 1700 can also include a user-input subsystem 1730 that allows a user of the electronic device 1700 to interact with electronic device 1700. For example, user-input subsystem 1730 can take a variety of forms, such as: a button, keypad, dial, touch screen, audio input interface, visual/image capture input interface, input in the form of sensor data, etc.

Electronic device 1700 can be (or can be included in) any electronic device with at least one network interface. For example, electronic device 1700 can include: a cellular telephone or a smartphone, a tablet computer, a laptop computer, a notebook computer, a personal or desktop computer, a netbook computer, a media player device, a wireless speaker, an IoT device, an electronic book device, a MiFi® device, a smartwatch, a wearable computing device, a portable computing device, a consumer-electronic device, a vehicle, a door, a window, a portal, an access point, a router, a switch, communication equipment, test equipment, as well as any other type of electronic computing device having wireless communication capability that can include communication via one or more wireless communication protocols.

Although specific components are used to describe electronic device 1700, in alternative embodiments, different components and/or subsystems can be present in electronic device 1700. For example, electronic device 1700 can include one or more additional processing subsystems, memory subsystems, networking subsystems, and/or display subsystems. Additionally, one or more of the subsystems may not be present in electronic device 1700. Moreover, in some embodiments, electronic device 1700 can include one or more additional subsystems that are not shown in FIG. 17. In some embodiments, electronic device 1700 can include an analysis subsystem that performs at least some of the operations in the communication techniques. Also, although separate subsystems are shown in FIG. 17, in some embodiments some or all of a given subsystem or component can be integrated into one or more of the other subsystems or component(s) in electronic device 1700. For example, in some embodiments program instructions 1722 are included in operating system 1724 and/or control logic 1716 is included in the one or more interface circuits 1718.

Moreover, the circuits and components in electronic device 1700 can be implemented using any combination of analog and/or digital circuitry, including: bipolar, PMOS and/or NMOS gates or transistors. Furthermore, signals in these embodiments can include digital signals that have approximately discrete values and/or analog signals that have continuous values. Additionally, components and circuits can be single-ended or differential, and power supplies can be unipolar or bipolar.

An integrated circuit can implement some or all of the functionality of networking subsystem 1714. This integrated circuit can include hardware and/or software mechanisms that are used for transmitting wireless signals from electronic device 1700 and receiving signals at electronic device 1700 from other electronic devices. Aside from the mechanisms herein described, radios are generally known in the art and hence are not described in detail. In general, networking subsystem 1714 and/or the integrated circuit can include any number of radios. Note that the radios in multiple-radio embodiments function in a similar way to the described single-radio embodiments.

In some embodiments, networking subsystem 1714 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein includes receiving signals from other electronic devices and possibly performing one or more processing operations on the received signals).

In some embodiments, an output of a process for designing the integrated circuit, or a portion of the integrated circuit, which includes one or more of the circuits described herein can be a computer-readable medium such as, for example, a magnetic tape or an optical or magnetic disk. The computer-readable medium can be encoded with data structures or other information describing circuitry that can be physically instantiated as the integrated circuit or the portion of the integrated circuit. Although various formats can be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematic diagrams of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used a Wi-Fi communication protocol as an illustrative example, in other embodiments a wide variety of communication protocols and, more generally, wireless communication techniques can be used. Thus, the communication techniques can be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments can be performed in hardware, in software or both. For example, at least some of the operations in the communication techniques can be implemented using program instructions 1722, operating system 1724 (such as a driver for an interface circuit in networking subsystem 1714) or in firmware in an interface circuit networking subsystem 1714. Alternatively or additionally, at least some of the operations in the communication techniques can be implemented in a physical layer, such as hardware in an interface circuit or interface circuitry in networking subsystem 1714. In some embodiments, the communication techniques are implemented, at least in part, in a MAC layer and/or in a physical layer in an interface circuit in networking subsystem 1714.

Note that the use of the phrases ‘capable of,’ ‘capable to,’ ‘operable to,’ or ‘configured to’ in one or more embodiments, refers to some apparatus, logic, hardware, and/or element designed in such a way to enable use of the apparatus, logic, hardware, and/or element in a specified manner.

While examples of numerical values are provided in the preceding discussion, in other embodiments different numerical values are used. Consequently, the numerical values provided are not intended to be limiting.

Moreover, while the preceding embodiments illustrated the use of wireless signals in one or more bands of frequencies, in other embodiments of the communication techniques electromagnetic signals in one or more different frequency bands are used. For example, these signals can be communicated in one or more bands of frequencies, including: a microwave frequency band, a radar frequency band, 900 MHz, 2.4 GHz, 5 GHZ, 6 GHz, 60 GHz, and/or a band of frequencies used by a Citizens Broadband Radio Service or by LTE.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein can be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
an antenna node configured to communicatively couple to an antenna; and
one or more interface circuits, communicatively coupled to the antenna node, wherein the one or more interface circuits are configured to:
perform neighborhood area network (NAN) pairing with a second electronic device, wherein, during the NAN pairing, the electronic device and the second electronic device exchange NAN identity keys (NIKs) or trigger identity keys (TIKs), and the NAN pairing conveys a BLE trigger capability of the second electronic device to the electronic device; and
provide, addressed to the second electronic device, a Bluetooth Low Energy (BLE) transportation discovery service (TDS) frame comprising an identity tag (ITag) corresponding to packet data in the BLE TDS frame and an NIK of the electronic device or a TIK of the electronic device.

2. The electronic device of claim 1, wherein the ITag equals N bits in a hash of the packet data and the NIK or the TIK.

3. The electronic device of claim 1, wherein the packet data comprises all fields in the BLE TDS frame preceding the ITag.

4. The electronic device of claim 1, wherein the BLE TDS frame comprises a Bloom Filter field with information corresponding to select information elements in a data stream and a timestamp of the electronic device.

5. The electronic device of claim 4, wherein the information corresponds to a hash of the select information elements and the timestamp.

6. The electronic device of claim 5, wherein the NIK or the TIK is a key of a hash function that performs the hash.

7. The electronic device of claim 4, wherein the information further corresponds to a nonce; and
wherein the nonce is changed in different BLE TDS frames.

8. The electronic device of claim 7, wherein the information corresponds to a hash of the select information elements, the timestamp and the nonce.

9. The electronic device of claim 4, wherein the information further corresponds to a value in an AdvA field in the BLE TDS frame; and
wherein the value in the AdvA field is changed in different BLE TDS frames.

10. The electronic device of claim 9, wherein the information corresponds to a hash of the select information elements, the timestamp and the value in the AdvA field.

11. The electronic device of claim 10, wherein one or more of the NIK, the TIK and the value of the AdvA field are used to generate a key of a hash function that performs the hash.

12. The electronic device of claim 1, wherein the TIK comprises: a random number; or corresponds to the NIK.

13. The electronic device of claim 1, wherein the BLE TDS frame comprises a Bloom Filter field with information corresponding to select information elements in a data stream and the select information elements are hashed prior to the electronic device generating the Bloom Filter field based at least in part on hashed values of the select information elements.

14. The electronic device of claim 1, wherein the BLE TDS frame comprises a Bloom Filter field with information corresponding to select information elements in a data stream that are randomized in the BLE TDS frame.

15. The electronic device of claim 1, wherein the ITag of the electronic device comprises a Group ITag (GITag) of a group of electronic devices, a source ITag (SITag) or a destination ITag (DITag).

16. The electronic device of claim 1, wherein the NIK of the electronic device comprises a Group NIK (GNIK) of a group of electronic devices; and
wherein the BLE TDS frame comprises a Bloom Filter field with information corresponding to select information elements in a data stream and the GNIK.

17. The electronic device of claim 1, wherein the BLE TDS frame comprises a TDS header field that indicates one or more of: a length of a Bloom Filter in the BLE TDS frame; a type of ITag present in the BLE TDS frame; whether a timestamp is used to compute a value of the Bloom Filter; and whether information elements in a data stream used to compute the value of the Bloom Filter are randomized.

18. The electronic device of claim 1, wherein the BLE TDS frame comprises a header extension field that indicates one or more of: whether the BLE TDS frame comprises a timestamp; a number of ITags included in the BLE TDS frame; and types of the one or more ITags.

19. A method for providing a Bluetooth Low Energy (BLE) transportation discovery service (TDS) frame, comprising:
by an electronic device:
performing neighborhood area network (NAN) pairing with a second electronic device, wherein, during the NAN pairing, the electronic device and the second electronic device exchange NAN identity keys (NIKs) or trigger identity keys (TIKs), and the NAN pairing conveys a BLE trigger capability of the second electronic device to the electronic device; and
providing, addressed to the second electronic device, the BLE TDS frame comprising an identity tag (ITag) corresponding to packet data in the BLE TDS frame and an NIK of the electronic device or a TIK of the electronic device.

20. A second electronic device, comprising:
an antenna node configured to communicatively couple to an antenna; and
one or more interface circuits, communicatively coupled to the antenna node, wherein the one or more interface circuits are configured to:
perform neighborhood area network (NAN) pairing with an electronic device, wherein, during the NAN pairing, the electronic device and the second electronic device exchange NAN identity keys (NIKs) or trigger identity keys (TIKs), and the NAN pairing conveys a BLE trigger capability of the second electronic device to the electronic device;
receive, associated with the electronic device, a Bluetooth Low Energy (BLE) transportation discovery service (TDS) frame comprising an identity tag (ITag) corresponding to packet data in the BLE TDS frame and an NIK of the electronic device or a TIK of the electronic device; and
identify a paired peer based at least in part on the ITag and the NIK or the TIK of the electronic device.
